(19) United States
(12) Patent Application Publication
(10) Pub. No.: US 2026/0366601 A1
(43) Pub. Date: Nov. 19, 2026

(54) ACTUATOR WITH ROTATABLE MOTOR ANGLE

(71) Applicant: TIMOTION TECHNOLOGY CO., LTD., New Taipei City (TW)

(72) Inventor: Yu-Chang LIN, New Taipei City (TW)

(21) Appl. No.: 19/267,519

(22) Filed: Jul. 12, 2025

(30) Foreign Application Priority Data
May 16, 2025 (TW) 114204972

(51) Int. Cl. F16H 25/20; F16H 25/24

(52) U.S. Cl. CPC F16H 25/2015; F16H 25/24; F16H 2025/2031; F16H 2025/2084; F16H 2025/209; F16H 2025/2093; F16H 25/2454

(57) ABSTRACT

An actuator with a freely rotatable motor angle is provided. The actuator (10) includes a telescopic mechanism (1), a motor (2), and a rotation mechanism (30). The telescopic mechanism (1) includes a lead screw (13) and a telescopic rod assembly (14). The telescopic rod assembly (14) sheathes the lead screw (13) and one end is movably threaded onto the lead screw (13). The motor (2) includes a motor body (22) and a transmission shaft (23) fixedly connected to the motor body (22) and driven to rotate by it. The rotation mechanism (30) is connected between the lead screw (13) and the motor (2) and enables relative rotation between the lead screw (13) and the motor (2).

### BACKGROUND OF THE DISCLOSURE

### Technical Field

The present disclosure relates to an actuator structure, and more particularly to an actuator with a freely rotatable motor angle.

### Description of Related Art

Linear actuators have been widely used in medical equipment such as hospital beds and electric chairs, daily equipment such as lifting desks, and other applications requiring telescopic motion for adjusting tilt angles or positional heights. They are widely used and broadly accepted.

A related-art linear actuators typically include a motor and a transmission mechanism. The motor includes a worm, and the transmission mechanism includes a lead screw and a worm gear sheathing the lead screw and meshed with the worm. The motor drives the worm to rotate, which in turn drives the worm gear and the lead screw to rotate, causing the inner tube of the linear actuator to extend or retract to adjust the tilt angle or positional height.

However, during assembly, linear actuators often need to accommodate the operational or spatial constraints of equipment, necessitating angle adjustments. Thus, designing a structure that allows the motor to smoothly rotate relative to the transmission mechanism at any angle, while ensuring that the wiring connecting the motor, circuit board, and limit switches is not affected by the rotation, has become a key challenge addressed by this disclosure.

In view of the above, the inventor has devoted significant effort to research, combined with theoretical principles, to address these issues, which forms the objective of the present disclosure.

### SUMMARY OF THE DISCLOSURE

The present disclosure provides an actuator with an arbitrarily rotatable motor angle. The motor may rotate relative to a stationary transmission shaft and the telescopic mechanism via a rotation mechanism, achieving the functionality of arbitrarily adjusting the motor angle.

In an embodiment of the present disclosure, an actuator with an arbitrarily rotatable motor angle is provided. The actuator includes a telescopic mechanism including a lead screw and a telescopic rod assembly, the telescopic rod assembly being sleeved around the lead screw, one end of the telescopic rod assembly being movably threadedly connected to the lead screw; a motor; and a rotation mechanism connected between the lead screw and the motor, and configured to drive the lead screw and the motor to rotate relative to each other, wherein when the motor is activated, the motor drives the rotation mechanism to rotate the lead screw, and when the motor is off, the motor is rotatable by an angle relative to the telescopic mechanism via the rotation mechanism.

In an embodiment of the present disclosure, the motor includes a motor body and a transmission shaft driven to rotate by the motor body, the rotation mechanism is a bevel gear assembly including a first bevel gear and a second bevel gear, the first bevel gear sheathes an end of the lead screw, and the second bevel gear sheathes an end of the transmission shaft and engaged with the first bevel gear, wherein when the motor is activated, the motor drives the lead screw to rotate via the transmission shaft and the bevel gear assembly, and when the motor is turned off, the motor is rotatable by an angle relative to the telescopic mechanism via the transmission shaft and the bevel gear assembly.

Based on the above, the transmission shaft is fixedly connected to the motor body, the first bevel gear sheathes the end of the lead screw, and the second bevel gear sheathes the end of the transmission shaft and engaged with the first bevel gear. When the motor is activated, it sequentially drives the transmission shaft, the bevel gear assembly, and the lead screw to rotate, thereby causing the telescopic rod assembly to extend or retract relative to the outer tube and realizing the telescopic function of the actuator. When the motor is deactivated, the user may manually pivot the entire motor, allowing it to rotate about the transmission shaft and via the bevel gear assembly relative to the telescopic mechanism, thereby enabling the actuator to arbitrarily adjust the motor angle.

Based on the above, the electrical connection between the transmission shaft and the motor adopts an arrangement in which the first circuit board and the second circuit board are disposed opposite to each other. A circular circuit is formed on the surface of one of the two circuit boards, while a probe connector is mounted on the surface of the other. The end of the probe connector is electrically attached to the circular circuit and is slidable along it, ensuring that as the second circuit board rotates with the motor relative to the first circuit board, the probe connector remains in stable electrical contact with the circular circuit. This provides the advantage of stable internal wiring within the actuator.

Further based on the above, the electrical connection between the transmission shaft and the motor also includes a first wire electrically connected with the first circuit board and the upper and lower limit switches, and a second wire electrically connected with the second circuit board and the motor body. The first circuit board, the upper and lower limit switches, and the first wire are embedded within the fixed base, while the second circuit board and the second wire are embedded within the housing. This internal wiring layout ensures that no excess wires or electrical components (such as the limit switches) are exposed on the actuator's exterior, eliminating the need for external wire clearance and cable management, thereby enhancing the actuator's overall aesthetic appearance.

### BRIEF DESCRIPTION OF THE DRAWINGS

FIG. 1 is an exploded perspective view of an actuator of the present disclosure.

FIG. 2 is an assembled perspective view of the actuator of the present disclosure.

FIG. 3 is a side view of the assembled actuator of the present disclosure.

FIG. 4 is a perspective view showing the usage state of a bevel gear assembly of the present disclosure.

FIG. 5 is a cross-sectional view of the assembled actuator of the present disclosure.

FIG. 6 is another cross-sectional view of the assembled actuator of the present disclosure.

FIG. 7 is a top schematic view showing the motor rotated at 0° relative to a telescopic mechanism.

FIG. 8 is a top schematic view showing the motor rotated at 45° relative to the telescopic mechanism.

FIG. 9 is a top schematic view showing the motor rotated at 135° relative to the telescopic mechanism.

FIG. 10 is a top schematic view showing the motor rotated at 180° relative to the telescopic mechanism.

FIG. 11 is a top schematic view showing the motor rotated at 225° relative to the telescopic mechanism.

FIG. 12 is a perspective cross-sectional view of the actuator of the present disclosure.

FIG. 13 is another perspective cross-sectional view of the actuator of the present disclosure.

### DETAILED DESCRIPTION

The detailed description and technical content of the present disclosure are provided below with reference to the drawings. However, the drawings are for illustrative purposes only and are not intended to limit the scope of the disclosure.

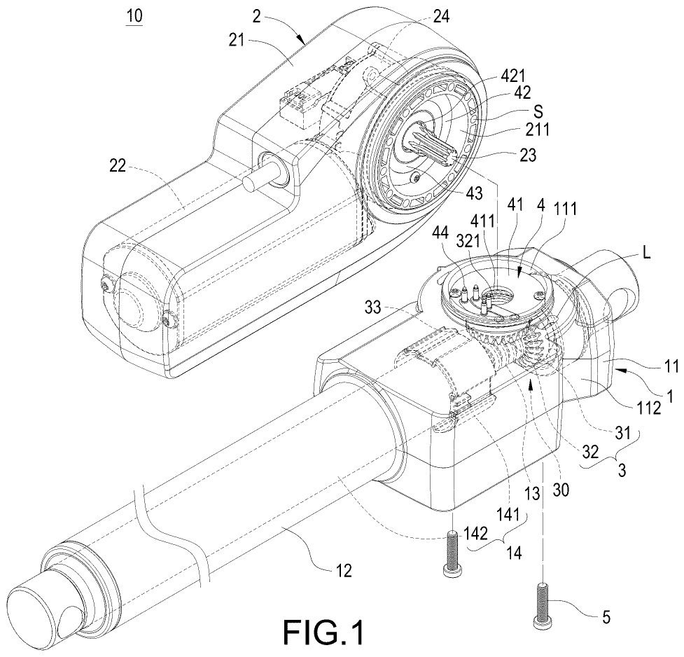

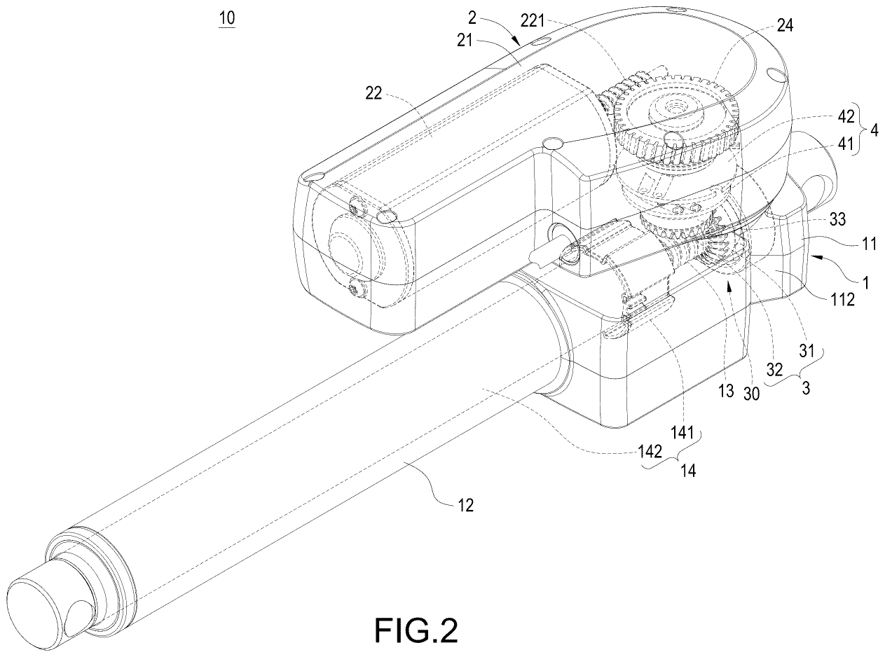

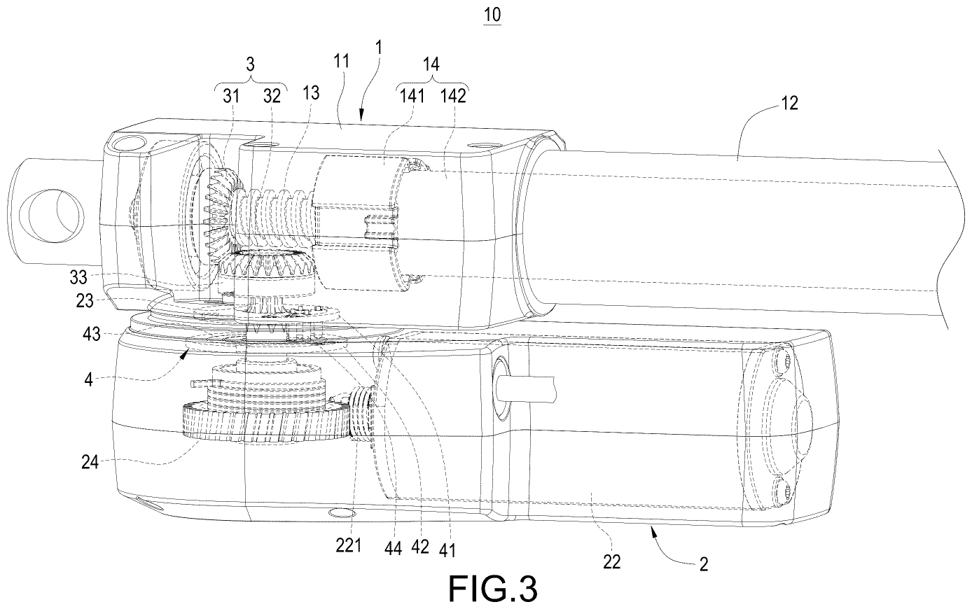

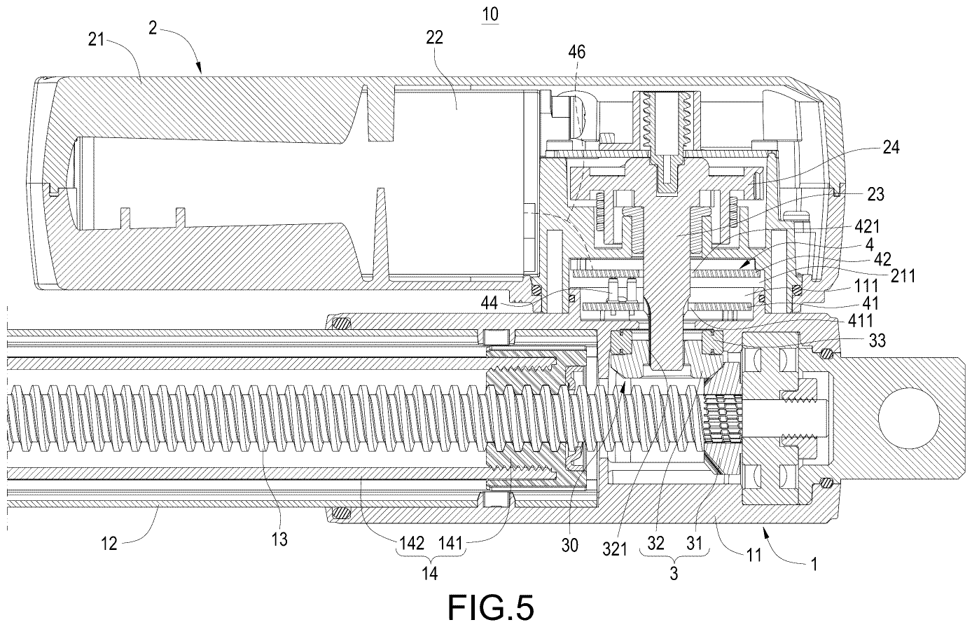

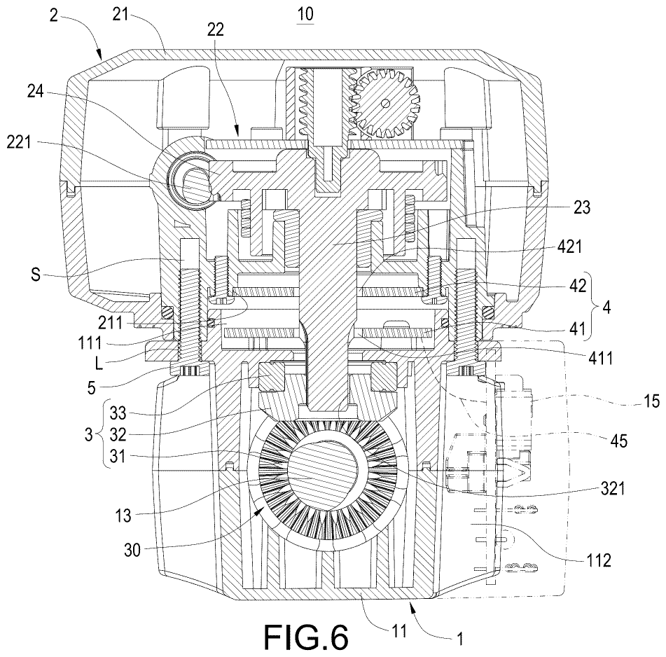

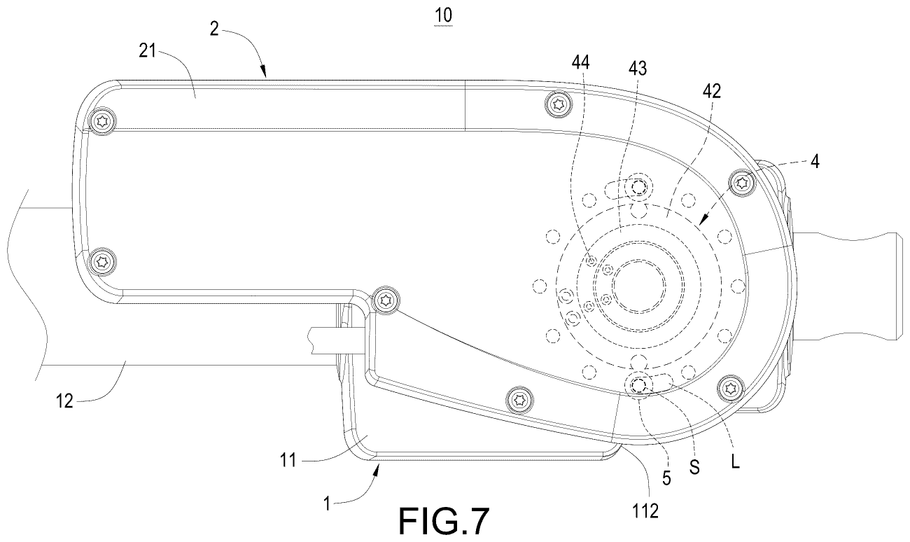

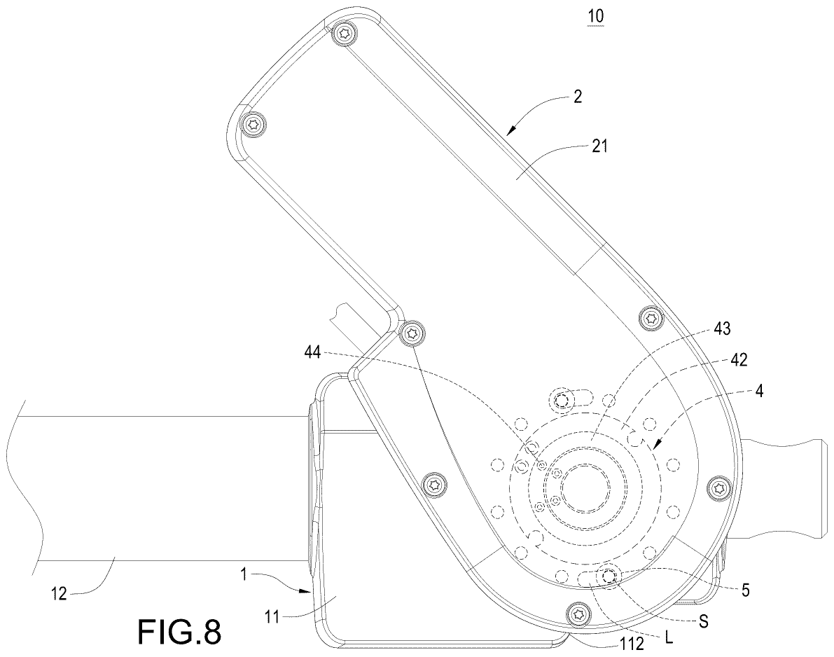

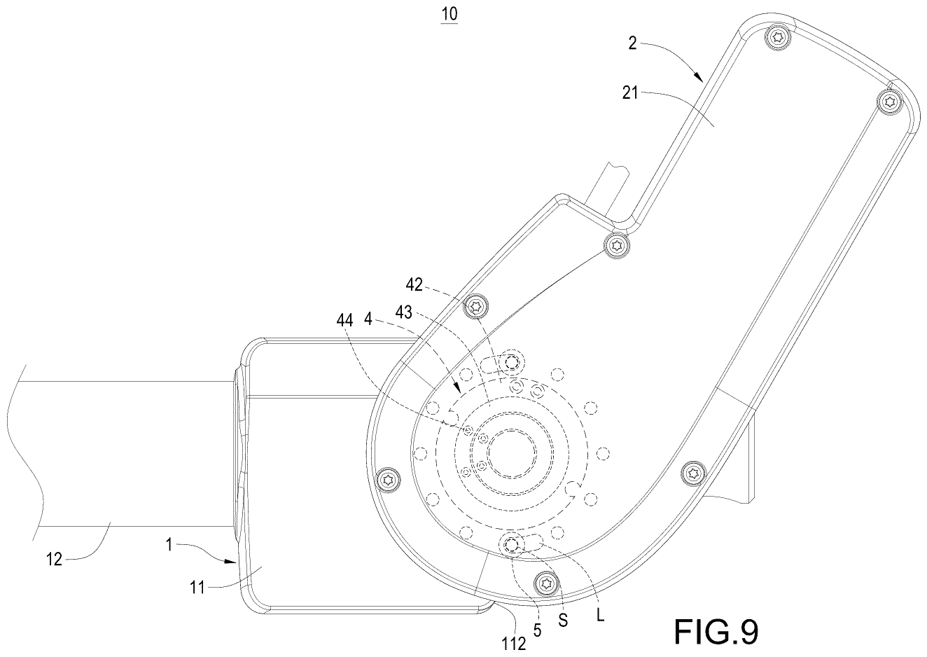

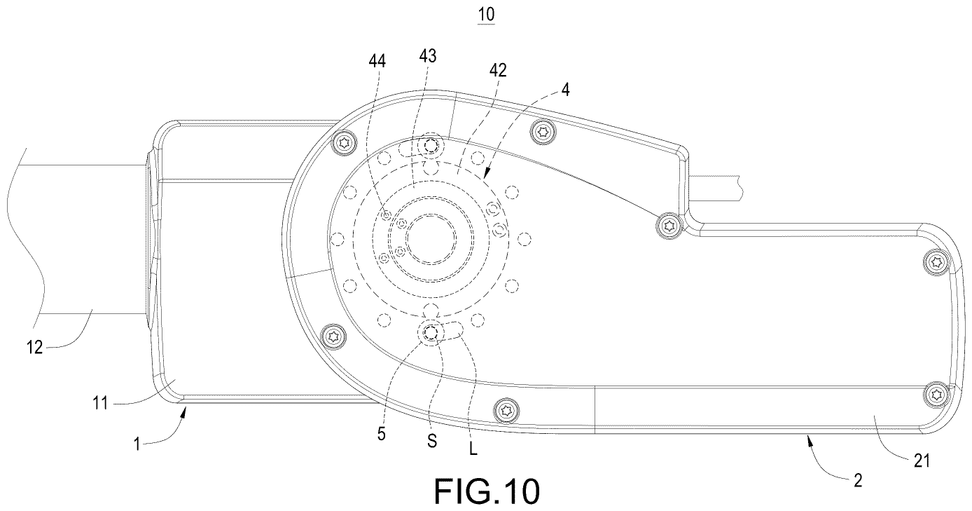

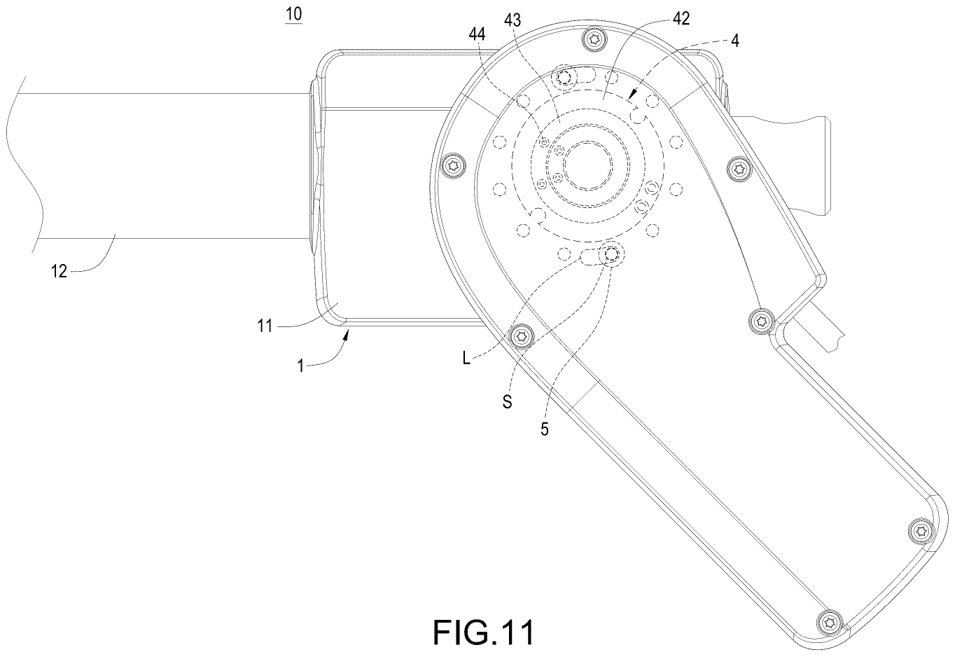

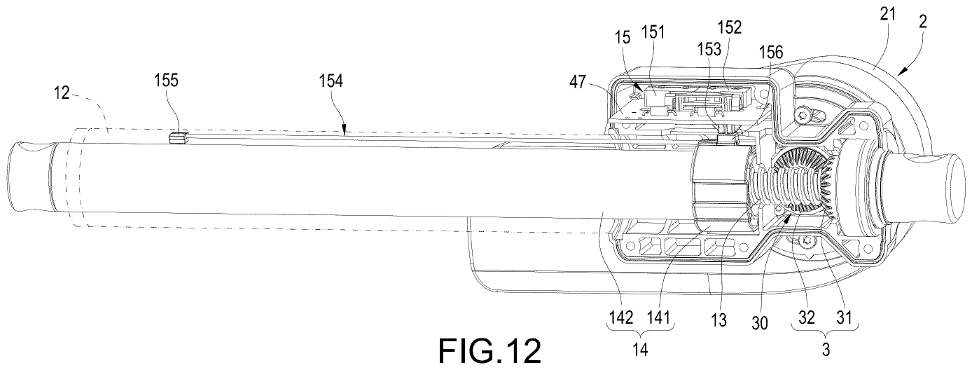

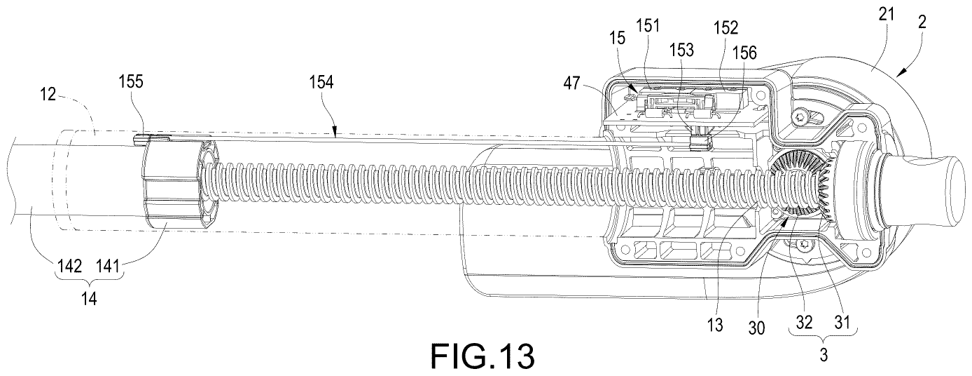

Referring to FIGS. 1 to 13, the present disclosure provides an actuator with an arbitrarily rotatable motor angle. The actuator 10 primarily includes a telescopic mechanism 1, a motor 2, and a rotation mechanism 30.

As shown in FIGS. 1 to 13, the telescopic mechanism 1 includes a fixed base 11, an outer tube 12, a lead screw 13, a telescopic rod assembly 14, and a limit switch assembly 15. One end of the outer tube 12 is fixedly connected to the fixed base 11 and sheathes the lead screw 13 and the telescopic rod assembly 14. One end of the lead screw 13 is mounted inside the fixed base 11, and the other end of the lead screw 13 extends into the outer tube 12. The telescopic rod assembly 14 sheathes the lead screw 13, with one end movably threadedly connected to the lead screw 13. The limit switch assembly 15 is disposed in the fixed base 11 corresponding to the telescopic rod assembly 14.

In detail, the telescopic rod assembly 14 includes a nut 141 and a telescopic rod 142. The nut 141 is threadedly connected to the lead screw 13 and restricted by the outer tube 12 from rotating, allowing the nut 141 to move only axially along the outer tube 12 when threaded with the lead screw 13. The telescopic rod 142 is movably sleeved on the lead screw 13, with one end fixedly connected to the nut 141 and the other end extending or retracting relative to the outer tube 12 as the nut 141 moves.

As shown in FIGS. 1 to 13, the motor 2 includes a housing 21, a motor body 22, a transmission shaft 23, and a worm gear 24. The motor body 22 includes a rotatable motor shaft 221. The motor body 22 and the transmission shaft 23 are mounted inside the housing 21. The worm gear 24 is rotatably mounted inside the housing 21 and meshes with the motor shaft 221. The transmission shaft 23 is mounted to the worm gear 24, such that the transmission shaft 23 is fixedly connected to and driven to rotate by the motor body 22.

As shown in FIGS. 1 to 6 and FIGS. 12 to 13, the rotation mechanism 30 is connected between the lead screw 13 and the motor 2 and enables relative rotation between the lead screw 13 and the motor 2. When the motor 2 is activated, it drives the rotation mechanism 30 to rotate the lead screw 13; when the motor 2 is not operating, it may rotate relative to the telescopic mechanism 1 via the rotation mechanism 30 to adjust the angle.

Further, in this embodiment, the rotation mechanism 30 is a bevel gear assembly 3, the bevel gear assembly 3 includes a first bevel gear 31 sleeved on the end of the lead screw 13 and a second bevel gear 32 sheathing the end of the transmission shaft 23 and meshed with the first bevel gear 31. The bevel gear assembly 3 is mounted inside the fixed base 11.

Additionally, the bevel gear assembly 3 includes a bearing 33 sheathing the second bevel gear 32 and positioned between the second bevel gear 32 and the fixed base 11, allowing the second bevel gear 32 to smoothly rotate relative to the fixed base 11 via the bearing 33.

Further, the fixed base 11 is provided with a first opening 111 corresponding to the second bevel gear 32, and the housing 21 is provided with a second opening 211 aligned with the first opening 111. The second bevel gear 32 is provided with an insertion hole 321 aligned with the first opening 111.

As shown in FIGS. 1 to 13, the actuator 10 further includes a circuit module 4, the circuit module 4 includes a first circuit board 41, a second circuit board 42, one or more circular circuits 43, one or more probe connectors 44, and a third circuit board 47. The first circuit board 41 and the third circuit board 47 are fixed to the telescopic mechanism 1. The second circuit board 42 is fixed to the motor 2, rotates with the motor 2, and is arranged opposite the first circuit board 41. The circular circuit 43 is formed on the surface of either the first circuit board 41 or the second circuit board 42. The probe connector 44 is mounted on the surface of the other circuit board, with its end electrically contacting the circular circuit 43 and capable of sliding along it, ensuring electrical connection between the first circuit board 41 and the second circuit board 42 via the circular circuit 43 and the probe connector 44.

In detail, the first circuit board 41 is fixed in the first opening 111, and the second circuit board 42 is fixed in the second opening 211. The first circuit board 41 includes a first through-hole 411, and the second circuit board 42 includes a second through-hole 421. The transmission shaft 23 rotatably passes through the first through-hole 411 and the second through-hole 421 and is fixedly inserted into the insertion hole 321, such that one end of the transmission shaft 23 is fixed to the worm gear 24 and the other end is fixed to the second bevel gear 32. When the motor body 22 activates the motor shaft 221 to rotate, it sequentially drives the worm gear 24, the transmission shaft 23, the second bevel gear 32, and the first bevel gear 31 to rotate. The third circuit board 47 is fixed inside the fixed base 11.

Thus, when the motor 2 is activated, it drives the lead screw 13 to rotate via the transmission shaft 23 and the bevel gear assembly 3. When the motor 2 is turned off, it may rotate relative to the telescopic mechanism 1 via the transmission shaft 23 and the bevel gear assembly 3 to adjust the angle.

The limit switch assembly 15 is disposed inside the fixed base 11 and arranged corresponding to the nut 141. As shown in FIGS. 1 to 3 and FIGS. 12 to 13, the limit switch assembly 15 includes an upper limit switch 151, a lower limit switch 152, a slider 153, and a push rod 154. The upper limit switch 151 and the lower limit switch 152 are mounted on the third circuit board 47 and correspond to the telescopic rod assembly 14. The push rod 154 is movably mounted in the outer tube 12, with its two ends respectively having an upper pushable portion 155 and a lower pushable portion 156. The slider 153 is movably disposed on the third circuit board 47, positioned between the upper limit switch 151 and the lower limit switch 152, and configured to move with the push rod 154. When the telescopic rod 142 retracts into the outer tube 12 to a preset limit retracted position, the nut 141 pushes the lower pushable portion 156 and drives the slider 153 to trigger the lower limit switch 152. When the telescopic rod 142 extends out of the outer tube 12 to a preset limit extended position, the nut 141 pushes the upper pushable portion 155 and drives the slider 153 to trigger the upper limit switch 151. Upon being triggered, the upper limit switch 151 and the lower limit switch 152 send signals to the motor body 22. Upon receiving the signals, the motor body 22 stops the motor shaft 221, thereby halting the rotation of the transmission shaft 23, the bevel gear assembly 3, and the lead screw 13, and preventing the nut 141 from moving beyond the preset limit positions.

In this embodiment, there are a plurality of circular circuits 43 and a plurality of probe connectors 44. The plurality of circular circuits 43 are arranged concentrically on the surface of the second circuit board 42, and the plurality of probe connectors 44 are arranged side by side on the surface of the first circuit board 41, with each probe connector 44 slidably and electrically contacting each circular circuit 43. Alternatively, the plurality of circular circuits 43 may be arranged side by side on the surface of the first circuit board 41, and the plurality of probe connectors 44 may be arranged concentrically on the surface of the second circuit board 42.

Furthermore, the circuit module 4 includes one or more first wires 45 and one or more second wires 46. The first wires 45 are electrically connected with the first circuit board 41 and the third circuit board 47. The first wires 45 are electrically connected to the first circuit board 41, the upper limit switch 151, and the lower limit switch 152. The second wires 46 are electrically connected between the second circuit board 42 and the motor body 22.

Although the circuit module 4 in this embodiment ensures stable electrical connection during arbitrary rotation of the motor 2 relative to the telescopic mechanism 1, the circuit module 4 is not essential and may be omitted as needed. The motor 2 and the telescopic mechanism 1 may also be electrically connected via the related-art wires or a single circuit board.

As shown in FIG. 1 and FIGS. 6 to 11, the actuator 10 further includes two or more locking elements 5. Either the fixed base 11 or the housing 21 is provided with two or more elongated slots L located on two sides of the first opening 111 and the second opening 211. The other of the fixed base 11 or the housing 21 is provided with a plurality of locking holes S arranged around the periphery of the first opening 111 and the second opening 211. Each locking element 5 passes through each elongated slot L and is secured to a portion of the locking holes S. The locking elements 5 are screws, but not limited thereto.

In detail, in this embodiment, the elongated slots L are formed in the fixed base 11, and the outer periphery of the fixed base 11 is provided with two or more recessed slots 112. Each elongated slot L is formed in the inner bottom wall of each recessed slot 112, facilitating the passage of the locking elements 5 through the elongated slots L. The locking holes S are formed in the housing 21. Alternatively, the elongated slots L may be formed in the housing 21, the recessed slots 112 may be formed in the outer periphery of the housing 21, and the locking holes S may be formed in the fixed base 11.

As shown in FIGS. 1 to 13, in the operational state of the actuator 10, the transmission shaft 23 is fixedly connected to the motor body 22, the first bevel gear 31 sheathes the end of the lead screw 13, and the second bevel gear 32 sheathes the end of the transmission shaft 23 and is meshed with the first bevel gear 31. When the motor 2 is activated, it sequentially drives the transmission shaft 23, the bevel gear assembly 3, and the lead screw 13 to rotate, causing the telescopic rod assembly 14 to extend or retract relative to the outer tube 12, achieving the actuator's telescopic function.

During assembly, the actuator 10 may accommodate the operational or spatial constraints of equipment, often requiring rotation of the motor 2 angle. In the present disclosure, when the motor 2 is deactivated, a user may manually rotate the entire motor 2, allowing it to pivot around the transmission shaft 23 via the bevel gear assembly 3 relative to the telescopic mechanism 1, enabling the actuator 10 to arbitrarily adjust the motor 2 angle.

Furthermore, rotating the motor 2 relative to the telescopic mechanism 1 may cause the wires inside the telescopic mechanism 1 and the motor 2 to twist, potentially damaging the wires and impairing the operation of the motor 2, the upper limit switch 151, or the lower limit switch 152.

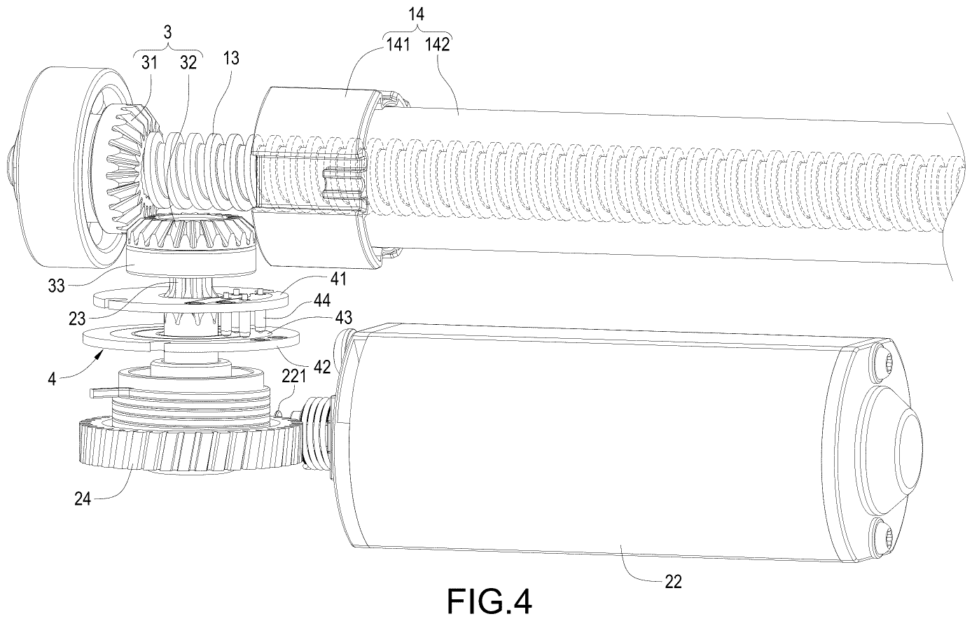

In contrast, as shown in FIGS. 4 to 11, the electrical connection between the transmission shaft 23 and the motor 2 in this embodiment employs a first circuit board 41 and a second circuit board 42 arranged oppositely. The circular circuit 43 is formed on the surface of either the first circuit board 41 or the second circuit board 42, and the probe connector 44 is mounted on the surface of the other circuit board, with its end electrically contacting and slidable along the circular circuit 43. When the second circuit board 42 rotates with the motor 2 relative to the first circuit board 41, the probe connector 44 maintains stable electrical contact with the circular circuit 43. Since the first circuit board 41 does not rotate, the first wires 45 do not twist, and the second wires 46 rotate with the motor body 22 and the second circuit board 42, preventing twisting and avoiding the related-art issue of wire tangling, thus providing the advantage of stable internal wiring for the actuator 10.

Additionally, this embodiment embeds the first circuit board 41 and the first wires 45 within the fixed base 11, and the second circuit board 42 and the second wires 46 within the housing 21. This internal wiring design ensures no excess wires are exposed on the actuator 10, eliminating the need for external wire management and clearance, thereby enhancing the actuator's aesthetic appearance.

As shown in FIGS. 1 and 7 to 11, schematic views illustrate the motor 2 rotated at 0°, 45°, 135°, 180°, and 225° relative to the telescopic mechanism 1. After the user adjusts the motor 2 to the desired angle, the plurality of locking holes S arranged in a circular pattern around the second opening 211 ensure that the elongated slots L align with some of the locking holes S at various angles. The locking elements 5 are then inserted through the elongated slots L and secured to the corresponding locking holes S, fixing the motor 2 to the telescopic mechanism 1 to prevent further rotation and positioning the motor 2. Conversely, removing the locking elements 5 from the elongated slots L and locking holes S allows the motor 2 to be unlocked from the telescopic mechanism 1, enabling further angle adjustments.

In summary, the actuator with an arbitrarily rotatable motor angle achieves its intended purpose, addresses the shortcomings of the related art.

1. An actuator, comprising:
a telescopic mechanism (1), comprising a lead screw (13) and a telescopic rod assembly (14), the telescopic rod assembly (14) adapted to sheathe the lead screw (13) and one end thereof movably connected to the lead screw (13);
a motor (2);
a rotation mechanism (30), connected between the lead screw (13) and the motor (2), and configured to drive the lead screw (13) and the motor (2) to rotate relative to each other, wherein when the motor (2) is activated, the motor (2) drives the rotation mechanism (30) to rotate the lead screw (13), and when the motor (2) is deactivated, the motor (2) is rotatable by an angle relative to the telescopic mechanism (1) via the rotation mechanism (30); and
a circuit module (4), comprising a first circuit board (41), a second circuit board (42), at least one circular circuit (43), and at least one probe connector (44), wherein the first circuit board (41) is fixed to the telescopic mechanism (1); the second circuit board (42) is fixed to the motor (2), rotates with the motor (2), and is disposed opposite to the first circuit board (41); the at least one circular circuit (43) is disposed on a surface of one of the first circuit board (41) and the second circuit board (42); the at least one probe connector (44) is mounted on a surface of another one of the first circuit board (41) and the second circuit board (42), and an end of the at least one probe connector (44) is electrically attached to the at least one circular circuit (43) and is slidable along the at least one circular circuit (43).

2. (canceled)

3. The actuator according to claim 1, wherein the motor (2) comprises a motor body (22) and a transmission shaft (23) driven to rotate by the motor body (22), the telescopic mechanism (1) comprises a limit switch assembly (15) disposed corresponding to the telescopic rod assembly (14), the circuit module (4) comprises at least one first wire (45) and at least one second wire (46), the at least one first wire (45) is electrically connected to the first circuit board (41) and the limit switch assembly (15), and the at least one second wire (46) is electrically connected to the second circuit board (42) and the motor body (22).

4. The actuator according to claim 1, wherein the motor (2) comprises a motor body (22) and a transmission shaft (23) driven to rotate by the motor body (22), the rotation mechanism (30) is a bevel gear assembly (3), the bevel gear assembly (3) comprises a first bevel gear (31) and a second bevel gear (32), the first bevel gear (31) is adapted to sheathe an end of the lead screw (13), and the second bevel gear (32) is adapted to sheathe an end of the transmission shaft (23) and engaged with the first bevel gear (31), wherein when the motor (2) is activated, the motor (2) drives the lead screw (13) to rotate via the transmission shaft (23) and the bevel gear assembly (3), and when the motor (2) is deactivated, the motor (2) is rotatable by the angle relative to the telescopic mechanism (1) via the transmission shaft (23) and the bevel gear assembly (3).

5. The actuator according to claim 4, further comprising a circuit module (4), the circuit module (4) comprising a first circuit board (41) and a second circuit board (42), wherein the telescopic mechanism (1) comprises a fixed base (11), the lead screw (13) and the bevel gear assembly (3) are mounted inside the fixed base (11), and the fixed base (11) is provided with a first opening (111) arranged corresponding to the second bevel gear (32); the motor (2) comprises a housing (21), the motor body (22) and the transmission shaft (23) are mounted inside the housing (21), the housing (21) is provided with a second opening (211) defined opposite to the first opening (111), the first circuit board (41) is fixed within the first opening (111), and the second circuit board (42) is fixed within the second opening (211).

6. The actuator according to claim 5, wherein the second bevel gear (32) is provided with an insertion hole (321) defined opposite to the first opening (111), the first circuit board (41) comprises a first through-hole (411), the second circuit board (42) comprises a second through-hole (421), and the transmission shaft (23) rotatably extends through the first through-hole (411) and the second through-hole (421) and is fixedly inserted into the insertion hole (321).

7. The actuator according to claim 5, further comprising at least two locking elements (5), wherein one of the fixed base (11) and the housing (21) is provided with at least two elongated slots (L) located on two sides of the first opening (111) and the second opening (211), another one of the fixed base (11) and the housing (21) is provided with a plurality of locking holes (S) arranged around a periphery of the first opening (111) and the second opening (211), and the at least two locking elements (5) extend through the at least two elongated slots (L) and are secured to at least two of the plurality of locking holes (S).

8. The actuator according to claim 7, wherein the at least two elongated slots (L) are defined on the fixed base (11), an outer periphery of the fixed base (11) is provided with at least two recessed slots (112), each of the elongated slots (L) is defined on an inner bottom wall of each of the recessed slots (112), and the plurality of locking holes (S) are defined on the housing (21).

9. The actuator according to claim 5, wherein the motor (2) comprises a worm gear (24), the motor body (22) comprises a rotatable motor shaft (221), the worm gear (24) is rotatably mounted inside the housing (21) and engages with the motor shaft (221), and one end of the transmission shaft (23) is fixed to the worm gear (24), and another end of the transmission shaft (23) is fixed to the second bevel gear (32).

10. The actuator according to claim 1, wherein the telescopic mechanism (1) comprises a fixed base (11) and an outer tube (12), one end of the outer tube (12) is fixedly connected to the fixed base (11) and is adapted to sheathe the lead screw (13) and the telescopic rod assembly (14), the telescopic rod assembly (14) comprises a nut (141) and a telescopic rod (142), the nut (141) is movably connected to the lead screw (13), the telescopic rod (142) is adapted to movably sheathe the lead screw (13), one end of the telescopic rod (142) is fixedly connected to the nut (141), and an opposite end of the telescopic rod (142) extends or retracts relative to the outer tube (12) as the nut (141) moves.

11. The actuator according to claim 10, wherein the telescopic mechanism (1) comprises a limit switch assembly (15), the limit switch assembly (15) comprises an upper limit switch (151), a lower limit switch (152), a slider (153), and a push rod (154), the upper limit switch (151) and the lower limit switch (152) are disposed corresponding to the telescopic rod assembly (14), the push rod (154) is movably mounted in the outer tube (12), the push rod (154) comprises an upper pushable portion (155) and a lower pushable portion (156) disposed on two ends thereof, and the slider (153) is disposed between the upper limit switch (151) and the lower limit switch (152) and moves with the push rod (154), wherein when the telescopic rod (142) retracts into the outer tube (12), the nut (141) pushes the lower pushable portion (156) and drives the slider (153) to trigger the lower limit switch (152), and when the telescopic rod (142) extends out of the outer tube (12), the nut (141) pushes the upper pushable portion (155) and drives the slider (153) to trigger the upper limit switch (151).
